(19) United States
(12) Patent Application Publication
(10) Pub. No.: US 2016/0148172 A1
(43) Pub. Date: May 26, 2016

(54) COMPUTER-IMPLEMENTED MANAGEMENT OF AIDS TO NAVIGATION

(71) Applicant: SEALITE PTY LTD, Somerville, VIC (AU)

(72) Inventor: Christopher Paul Procter, Somerville (AU)

(73) Assignee: Sealite PTY LTD, Somerville (AU)

(21) Appl. No.: 14/899,383

(22) PCT Filed: Jun. 17, 2014
(86) PCT No.: PCT/AU2014/000625

§ 371 Date: Dec. 17, 2015

(30) Foreign Application Priority Data
Jun. 17, 2013 (AU) 2013902168

(51) Int. Cl. G06Q 10/00; G06F 17/30; G01C 21/00

(52) U.S. Cl. CPC G06Q 10/20; G01C 21/00; G06F 17/30289; G06F 17/30345; G06F 17/30424

(57) ABSTRACT

The present invention provides computer-implemented methods and systems for managing aids to navigation (AtoNs). In one embodiment, the method comprises maintaining an AtoN database, recording, in the AtoN database, an identifier for each AtoN asset, and associating, with each identifier, lifecycle information relating to the corresponding AtoN asset. The method may be performed by a mobile device, and functions of the mobile device can be utilised to provide additional advantages at the time of deployment or servicing of an AtoN—in particular, to record the current location of an AtoN, its colour or flash rate, or the tilt of one or more parts of the AtoN.

### FIELD OF THE INVENTION

The present invention relates generally to computer-implemented methods and systems for management of aids to navigation.

### BACKGROUND OF THE INVENTION

Marine navigation can be a difficult exercise, particularly in coastal areas or near shallow or narrow channels. Accordingly, many organisations (such as national and international port authorities) operate hundreds or even thousands of marine aids to navigations (AtoNs). On land, these AtoNs include lighthouses and beacons, and at sea they include buoys of various descriptions, and in some cases light vessels. AtoNs may assist navigators by providing a visual aid (e.g. a colour marking or a flashing light), a warning sound (e.g. a fog horn) or by transmitting a radar or other electronic signal, which warns the navigator of any dangers and/or guides them along a safe course.

Of course, AtoNs are also used in other industries, in particular the aviation industry. Although the present invention will be described with particular reference to the maritime industry, it will be understood that it has broader application to other industries.

The ongoing maintenance and management of AtoNs in the field represents a distinct challenge for many organisations. Most devices require (at least) annual maintenance—for a buoy, this may include including battery checks, cleaning and anti-fouling, parts replacement, etc. In seasonal environments (northern hemisphere), AtoNs are often physically removed from service and returned the following season. As these are commodity devices—an AtoN of a particular make or model is practically indistinguishable from another—it therefore becomes difficult, if not impossible, to track which device is where and to retrieve information regarding its lifecycle. This means that organisations cannot readily identify the location of a particular device (including whether or not it is in service or storage), or provide information about its present state. This causes significant difficulties in not only maintaining the AtoN assets, but also in forecasting budgetary requirements for continuing operations.

### SUMMARY OF THE INVENTION

According to an aspect of the present invention, there is provided a computer-implemented method of managing a plurality of aids to navigation, comprising:
(a) maintaining an AtoN database;
(b) recording, in the database, an identifier for each AtoN asset; and
(c) associating, with each identifier, lifecycle information relating to the corresponding AtoN asset.

Lifecycle information, for the purposes of this specification, is taken to include deployment information for an AtoN asset, as well as maintenance records for the AtoN asset. By way of example, the lifecycle information may include:
(i) a current location of the AtoN asset;
(ii) historical locations of the AtoN asset;
(iii) current deployment details of the AtoN asset;
(iv) historical deployment details of the AtoN asset;
(v) maintenance records of the AtoN asset; or
(vi) operational mode usage data for the AtoN asset.

The AtoN database may contain data for a variety of AtoN asset types, including buoys, lanterns, power supplies and fixed structures. Further details (such as financial or technical information) may be recorded for each AtoN asset, such as the type of the asset, its technical specifications, its manufacturer, its purchase date and price.

The current and historical locations of the AtoN asset may be identified using a station identifier. A station may be a pre-set location for assets, and each station may allow multiple assets to be associated with it at the same time. For example, an individual station may include several assets, such as a buoy, a lantern and a power supply.

The present invention may be implemented using a computer system having one or more computer servers, to maintain the AtoN database, and one or more user terminals. The user terminals may communicate lifecycle information for an AtoN asset to the server, to enable the server to update the database with live information.

The user terminals may include mobile computing devices, such as mobile phones which could each run an application (app) designed to interact with the computer server(s). The mobile computing device may include a positioning system which could be used to assist with updating the current location of an aid to navigation—for example, the position of the mobile computing device at a given time could be entered as the current location for a particular AtoN asset. Alternatively, the nearest known deployment location (e.g. a particular station) could be identified and the user could be prompted to confirm this as the current location of the aid to navigation.

If an AtoN asset uses a solar panel to perform its function—e.g. to charge a battery which powers a light—the position of the mobile computing device may also be used to calculate a desired tilt of the solar panel to improve its efficiency. Furthermore, the mobile computing device may include an internal tilt-meter, which in this case could be used to measure the angle of the solar panel.

For some AtoN assets, such as marine lanterns, the angle of the asset itself is also extremely important. In such cases, the tilt-meter of the mobile computing device could also be used to measure the angle (e.g. relative to horizontal) of the asset itself.

The mobile computing device may include a camera. The camera may be used to assess visual features of an AtoN asset, such as its colour or (if a video camera is available) a flash rate of a light on the asset. This information may be uploaded to the AtoN database and tracked over time, and/or may be used as part of a maintenance operation so that the worker can test the operating modes of the AtoN asset.

In a second aspect of the present invention, there is provided a computer-implemented method of managing a plurality aids to navigation, comprising:
(a) obtaining lifecycle information for an AtoN asset; and
(b) updating an AtoN database with the lifecycle information.

The AtoN database may be updated by transmitting the lifecycle information over a computer network to a server maintaining the AtoN database.

In a third aspect of the present invention, there is provided a computer-implemented method of assessing an AtoN asset comprising:
(a) obtaining a visual and/or audio recording of the AtoN asset;
(b) measuring one or more visual and/or audio characteristics of the AtoN asset, from the recording; and
(c) comparing the one or more measured characteristics to one or more corresponding desired characteristics of the AtoN asset.

The one or more measured (and desired) characteristics may include a colour of the AtoN asset, or a flash rate of a light on the AtoN asset.

The mobile computing device may include an internal tilt meter. In such cases, a further aspect of the present invention may provide a computer-implemented method of deploying an AtoN asset using a mobile computing device having an angle measuring means to measure an angle of tilt of the mobile computing device, the method comprising:
(a) measuring, using the angle measuring means, an angle of the AtoN asset or a part thereof;
(b) comparing the measured angle to a desired angle of the AtoN asset or part thereof; and
(c) adjusting the angle of the AtoN asset or part thereof based on the comparison of the measured angle to the desired angle.

According to a further aspect of the present invention, there is provided a computer-implemented system for managing a plurality of aids to navigation, comprising:
(a) means for maintaining an AtoN database;
(b) means for recording, in the database, an identifier for a plurality of AtoN assets; and
(c) means for associating, with each identifier in the database, lifecycle information relating to the corresponding AtoN asset.

According to a further aspect of the present invention, there is provided a computer-implemented system for managing a plurality of aids to navigation, said system comprising one or more computers including:
(a) at least one processor;
(b) at least one storage medium operatively coupled to said processor, said storage medium containing program instructions for execution by said processor, said program instructions causing said processor to execute the steps of the method of any one of the above methods.

According to a still further aspect of the present invention, there is provided a tangible computer-readable medium having computer-executable instructions stored thereon for directing a programmable device to perform any one of the above methods.

A detailed description of one or more embodiments of the invention is provided below, along with accompanying figures that illustrate by way of example the principles of the invention. While the invention is described in connection with such embodiments, it should be understood that the invention is not limited to any embodiment. On the contrary, the invention encompasses numerous alternatives, modifications and equivalents.

For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF DRAWINGS

FIG. 1 shows a schematic block diagram of a computer-implemented system for managing a plurality of aids to navigation, in accordance with a representative embodiment of the present invention.

FIGS. 2 to 10 depict screenshots from a mobile app in accordance with an embodiment of the present invention.

### DETAILED DESCRIPTION

### System Architecture

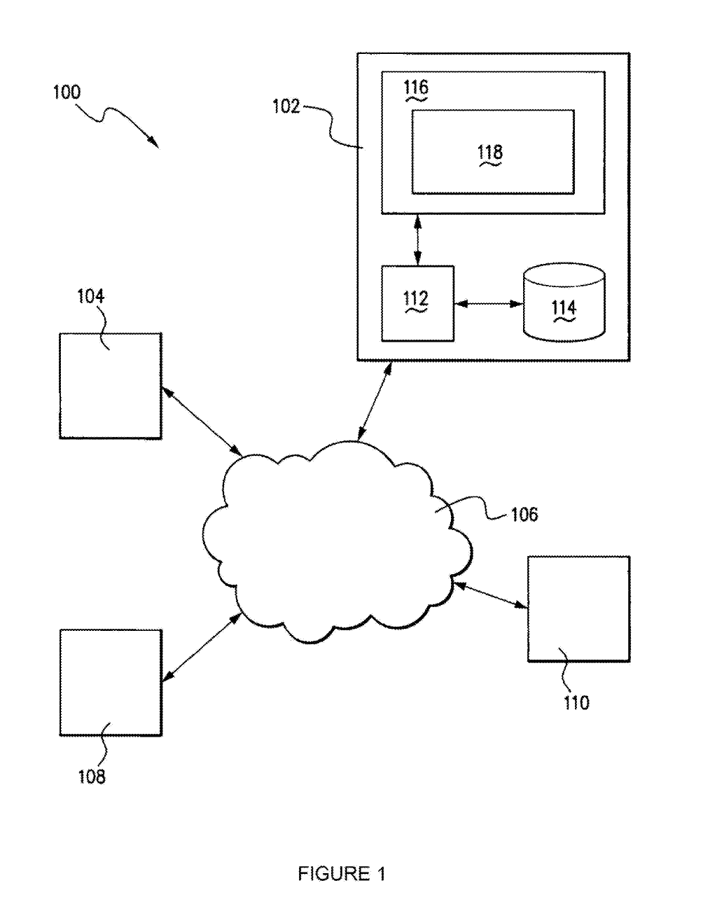

FIG. 1 illustrates an exemplary system 100 in which preferred embodiments of the invention may be implemented. The system includes a server 102 and at least one user terminal 104, both of which are connected to a network 106, which may be, for example, the Internet. Also connected to the network 106 are a plurality of user terminals and/or servers, e.g. 108, 110. It will be appreciated that FIG. 1 depicts the system 100 schematically only, and is not intended to limit the technology employed in the servers, user terminals and/or communication links. The user terminals in particular may be wired or wireless devices, and their connections to the network may utilize various technologies and bandwidths. For example, applicable user terminals include (without limitation): PC's with wired (e.g. LAN, cable, ADSL, dial-up) or wireless (e.g. WLAN, cellular) connections; and wireless portable/handheld devices such as PDA's, tablet computers including Apple iPads, or mobile/cellular telephones and smartphones. These devices also may include input means, such as a mouse and keyboard, stylus or other pointing device or system, or a touch screen, to enable the users to make selections and input data. The protocols and interfaces between the user terminals and the servers may also vary according to available technologies, and include (again without limitation): wired TCP/IP (Internet) protocols; GPRS, WAP and/or 3G protocols (for handheld/cellular devices); Short Message Service (SMS) messaging for digital mobile/cellular devices; and/or proprietary communications protocols.

The server 102 includes at least one processor 112 as well as at least one database 114, which would typically be stored on a secondary storage device of the server 102, such as one or more hard disk drives. Server 102 further includes at least one storage medium 116, typically being a suitable type of memory, such as random access memory, for containing program instructions and transient data related to the operation of the valuation system as well as other necessary functions of the server 102. In particular, memory 116 contains a body of program instructions 118 implementing the method and system in accordance with preferred embodiments of the invention. The body of program instructions 118 includes instructions for managing a plurality of aids to navigation, the operation of which will be described hereafter. It should be appreciated in relation to the configuration of the server 102 that one or more of the database 114, storage medium 116, and body of program instructions 118, may be provided at a remote location (such as for a cloud computing configuration).

It should be appreciated that the hardware used to implement the method of the invention may be conventional in nature or specifically designed for the purpose. The hardware structure shown in FIG. 1 is merely one possible embodiment and any other suitable structure may be utilised.

In accordance with the present invention, an AtoN database is maintained for a plurality of AtoN assets. This database will typically reside on the server 102. It will be accessible and updateable from user terminals e.g. 104, which can access the AtoN database using either a web interface or (where the user terminal is a mobile computing device such as a mobile phone or tablet computer) a specific mobile app. The present invention will be described with particular reference to the interaction of the computer server 102 with mobile computing devices.

### AtoN Database

Each AtoN in the database will have an identifier. This could be assigned by order of entry into the database, could be simply an AtoN serial number, could be a user denominated string, could be formed by concatenating descriptive terminology for the asset, or by any other suitable means. The data fields in the AtoN database, for each AtoN asset, may vary in different embodiments, and depending on the type of the AtoN asset. By way of (non-limiting, non-exhaustive) example only, some possible data fields are shown below:

| Asset Data for Marine Lanterns | Asset Data for Marine Buoys |
|---|---|
| Type of lantern (name or model | Type of BUOY (name or model |
| number, graphic representation) | number, or graphic representation) |
| Type of navigation aid as described | Type of navigation aid as |
| by IALA Maritime Buoyage | described by IALA Maritime |
| System | Buoyage System |
| Serial number | Serial number |
| AtoN Category (as described | Asset value |
| in IALA recommendation | |
| 0-130). i.e. Category 1, | |
| 2 or 3. | |
| Visible range | Diameter |
| Flash code | Material |
| Date of installation | Mooring chain size |
| GPS location | Water depth |
| Station name (as specified by Port | Mooring weight |
| Authority) | |
| Manufacturer | Date of installation |
| Asset value | GPS location |
| Owner (Port Authority) | Manufacturer |
| Photo | Owner (Port Authority) |
| Installation type | Photo |
| Installer details | Installer details |
| Other notes | Station name |
| | Other notes |

Preferably, maintenance records for each AtoN asset are also recorded in the AtoN database and associated with the AtoN asset identifier. By way of (non-limiting, non-exhaustive) example, some possible maintenance data fields are shown below:

| Maintenance | |
|---|---|
| Data for Marine Lanterns | Maintenance Data for Marine Buoys |
| Light sensor operating | Buoy (name or model) |
| Flash code setting | Reference to installation (where it is and what |
| | it is) |
| Battery voltage | Check for damage |
| Solar module charging | Vandalism |
| Cabling condition | Freeboard |
| Cleaning | Day marks in good condition |
| Vandalism | Colour integrity |
| Damage report | Mooring |
| Replacement (log reason) | Marine growth |
| Photo | Cleaning |
| Date of maintenance | Replacement reason |
| Contractor details | Photo |
| | Other information |
| | Contractor details |

The above data fields are exemplary only. Additional data fields (such as) manufacturing date, purchase date, purchase price etc) could also be included. Additional types of AtoN assets may be included in the database, including power supplies.

A location may be specified using a station name, which may be a pre-set location for assets. Each station may allow multiple assets to be associated with it at the same time. For example, an individual station may include several assets, such as a buoy, a lantern and a power supply.

The database may be configured and/or backed up to maintain historical records for each AtoN asset.

### Server Platform

The platform of the server 102 functions as the central hub for the computer system of the present invention. In this embodiment, it provides the following functionality:
Data synchronisation and management for mobile clients;
Brokering communication and data exchange between multiple mobile clients;
Authentication and identity management for mobile clients, including creation and maintenance of user accounts and profile administration;
Integration with external systems (if required);
Dispatching notifications and alerts to mobile clients;
Reporting and analytics functionality; and
System administration.

The server platform may use any of a variety of known content management system, and the database may be in any of various typical forms (e.g. SQL).

### User Terminals—Mobile Application

Given that the AtoNs are deployed in the field, in many locations that are a long way from any desktop computer, it is desirable for the AtoN database to be accessible using a mobile app on a mobile computing device. The mobile app, in this embodiment, is responsible for communicating user-initiated actions to the server (such as updating the service history for an AtoN), and acting on—or requesting—information from the server (for instance, downloading the previous service history for an AtoN in the field). Preferably, the mobile app is fast and responsive, such that primary activities can be achieved with a minimum of effort. This is particularly important in the AtoN service environment, where users may be working in challenging environmental conditions.

The main functions of the mobile app are:
Enable user login (i.e. authentication);
Retrieving information for specific AtoN assets, for example by allowing a user to search for an AtoN asset based on a specified location;
Enabling a user to capture and record asset information, including asset identification information, usage (including maintenance) information or financial or technical information;
Synchronisation of data between the mobile communication device and the AtoN database; and
Various miscellaneous functions, such as providing terms and conditions, menu screens, ‘about’ information, etc.

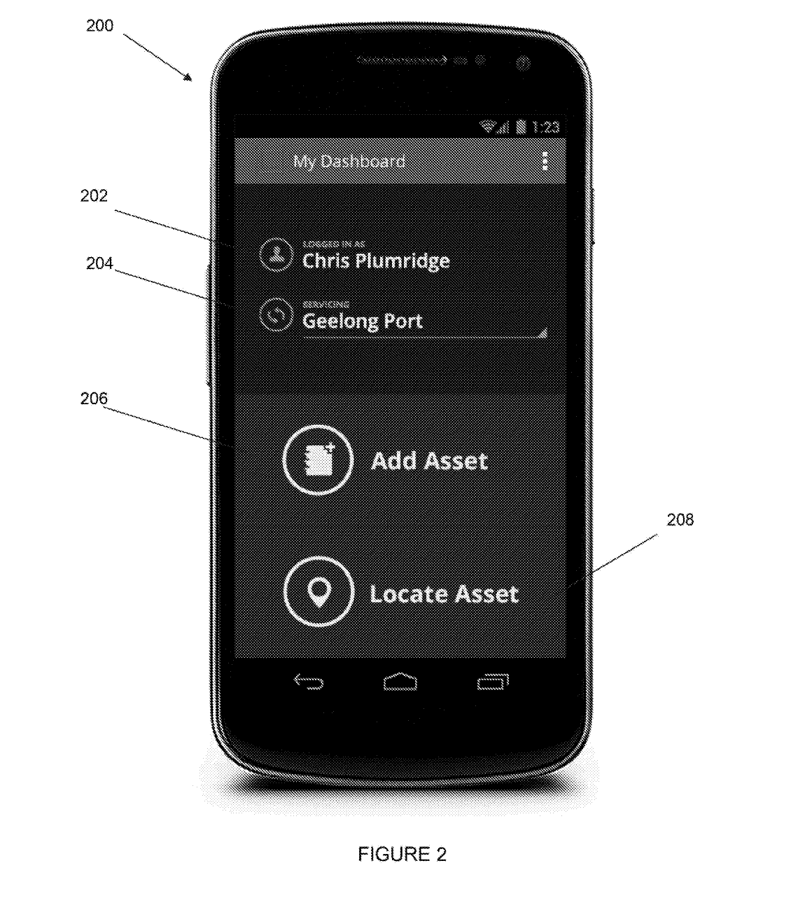

FIG. 2 depicts a main menu screen 200 from a mobile app in accordance with an embodiment of the present invention. The screen shown in FIG. 2 is the ‘Dashboard’, and displays information about the user 202, the area being serviced 204, and also provides virtual buttons to access the primary functions of the mobile app—an “Add Asset” button 206 and a “Locate Asset” button 208. For the purposes of illustrating the present invention, these functions of the mobile app will be described in detail.

Mobile app clients 104, 108, 110 may communicate with the server 102 using best-practice RESTful protocols. Of course, a browser-based interface may also be used in some embodiments.

### Mobile App Functions—Login

The mobile app in this embodiment requires end-users to be logged in, in order to authenticate and identify them and manage permissions and visibility of data. The login prompt will occur the first time the app is run.

In this embodiment, login is a one-time, set-and-forget process, where a user enters a username and password when the app is first launched. The authentication details will not need to be re-entered unless the user manually logs out. The login details 202 are displayed on the dashboard screen 200.

The login functionality enables the system to restrict access to data in the database to authorised users, and to record which user makes a particular update to the AtoN database.

### Mobile App Functions—Add Asset

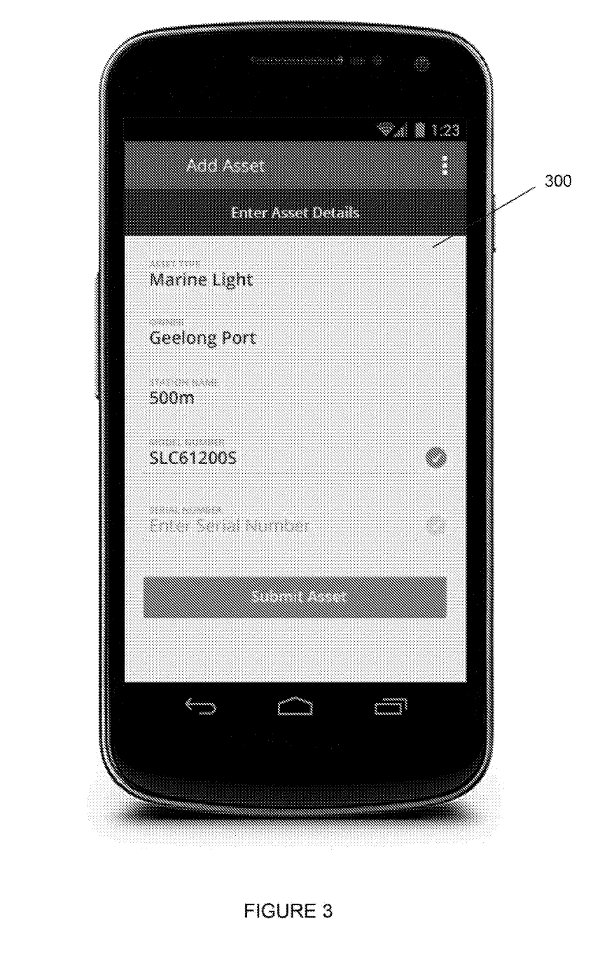

The “Add Asset” button 206 enables a user to add a new AtoN asset to the database. The user will be taken to the screen shown in FIG. 3, where they can record technical product information (make, model, serial number etc) for the new asset, via the mobile app. The new asset details may be entered at various stages—for example, when the asset is purchased, or on first-time commissioning of the device.

### Mobile App Functions—Locate Asset

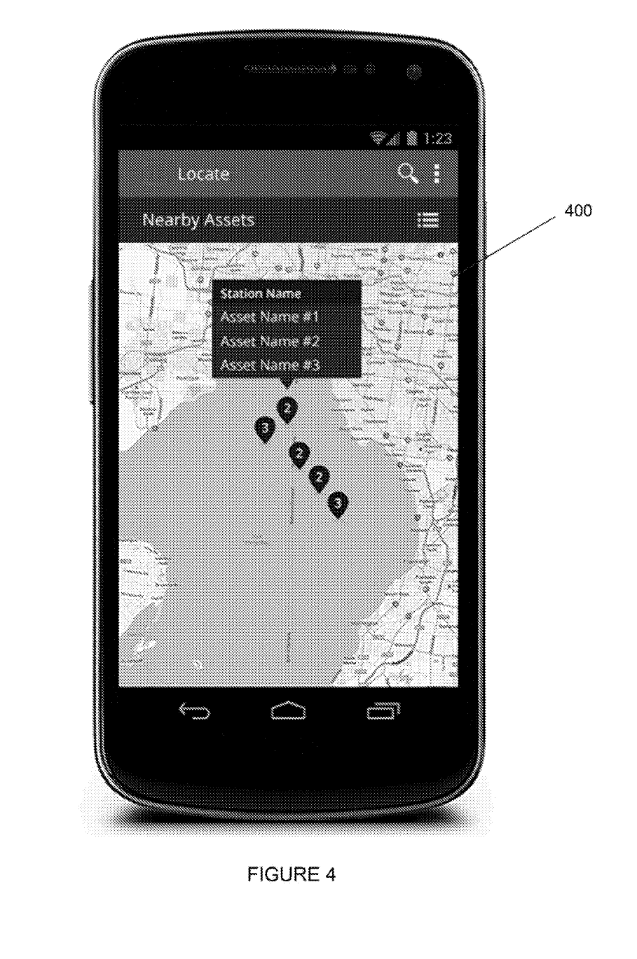

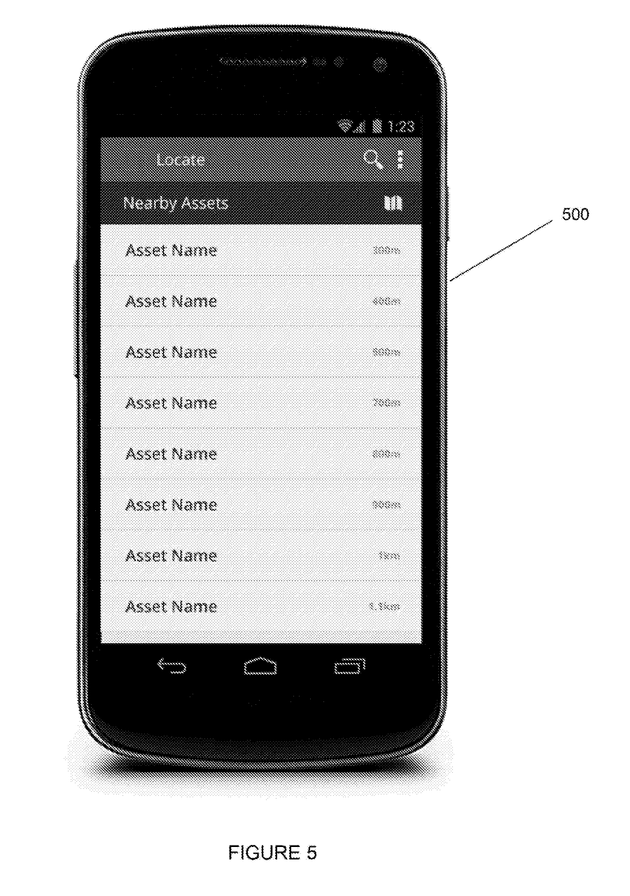

The locate asset button 208 of the mobile app allows a user to retrieve data from the AtoN database for an asset. Various methods may be provided to enable a user to locate an AtoN asset:
Direct lookup—the user can manually enter a unique AtoN identifier (e.g. serial number, or similar);
Location-based shortlist—(where possible) the mobile app will intelligently filter a known list of AtoN assets, based on the current position (latitude/longitude) of the mobile computing device (running the mobile app). The user can then select the desired item from a short-list of candidates. FIG. 5 shows an example of this type of shortlist.
Map-based location—FIG. 4 shows how the location of nearby AtoN assets may be displayed on a map, from which the user can select the desired device.

Once a particular asset is located and selected by the user, the mobile app will then retrieve information from the database for the selected AtoN asset, and allow the user to manage that information.

### Mobile App Functions—Asset Management

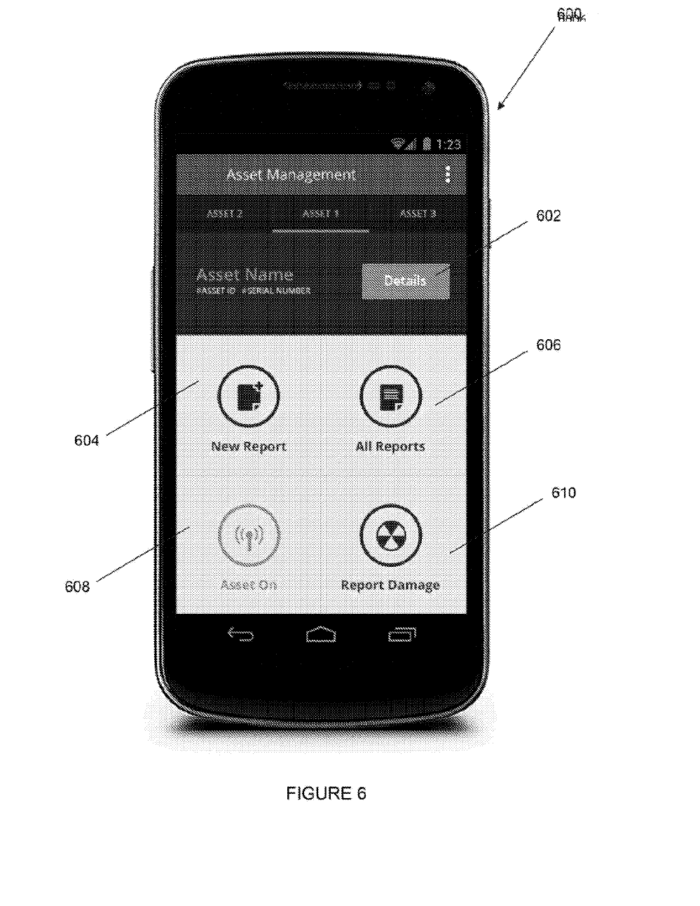

Once an AtoN asset has been selected as described above, the user is able to manage the information in the database for that asset. FIG. 6 shows the Asset Management screen, which allows a user to view, add or edit information for a particular asset. They can do so by accessing the Details button 602, New Report button 604, All Reports button 606, Asset On button 610 (to indicate whether an asset is currently in use), or Report Damage button 610 (to enable a user to report damage without providing a full report).

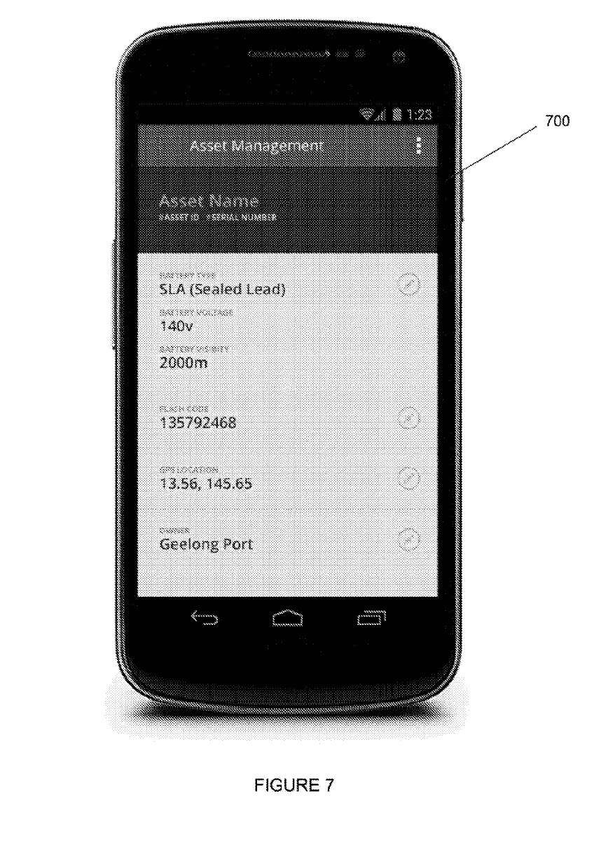

When re-deploying an existing device, the user may access the asset details via the Details button 602. As shown in the screen 700 in FIG. 7, the recorded asset details may be displayed, and the GPS location of the device may be edited by the user from this screen.

Additional deployment information may also be recorded at the time of installation, which may include the implemented flash code (if applicable), the water depth (if applicable) and the mooring details (e.g. chain size, length, etc., if applicable). The mobile app may intelligently assist the user, by automatically entering data (such as current date, time, GPS location) or by auto-completing data. Many mobile computing devices include GPS location systems, which can be used to assist the user.

Furthermore, many mobile computing devices also comprise an internal tilt-meter. The present invention may take advantage of this during installation—for example, it may be used to ensure that an AtoN asset is deployed at a desired orientation. In particular, the visual light output of a marine lantern typically peaks at exactly horizontal, with a focal beam width of approximately 9 degrees (−4.5 deg/+4.5 deg). Therefore, it is very important that marine lanterns be mounted horizontal so that the light output is centred to the approaching mariner. Therefore, the tilt-meter may be used upon installation of the marine lantern to ensure that it is installed at an appropriate angle.

The tilt-meter may also be used to provide other advantages, in combination with its GPS location feature. For example, the app may determine, based on the GPS location, a desired angle for a solar panel to achieve optimum charging efficiency (depending on the latitude of the installation). The tilt metre can then be used to ensure that the solar panel associated with a specific AtoN asset is oriented at the desired angle. Alternatively, the orientation of the solar panel could be measured, and then mobile application could calculate and displays a measure of the efficiency of the solar array, based on the global positioning information.

For example, to optimise solar collection during winter months, a typical calculation is to multiply the installation latitude by 0.89, then add 24 degrees. For instance, if the latitude is 35 degrees, according to this algorithm an installer would tilt the solar panel at approximately a 55-degree angle from horizontal (35×0.89=31.15+24=55.15). The app could be used to both determine the optimum angle and to measure the angle of installation.

### Mobile App Functions—Maintenance

Maintenance of AtoNs is typically conducted annually (or seasonally in some northern hemisphere environments). Maintenance personnel are required to conduct a range of checks (batteries, sensors, solar panels) and routine maintenance activities (cleaning, antifouling).

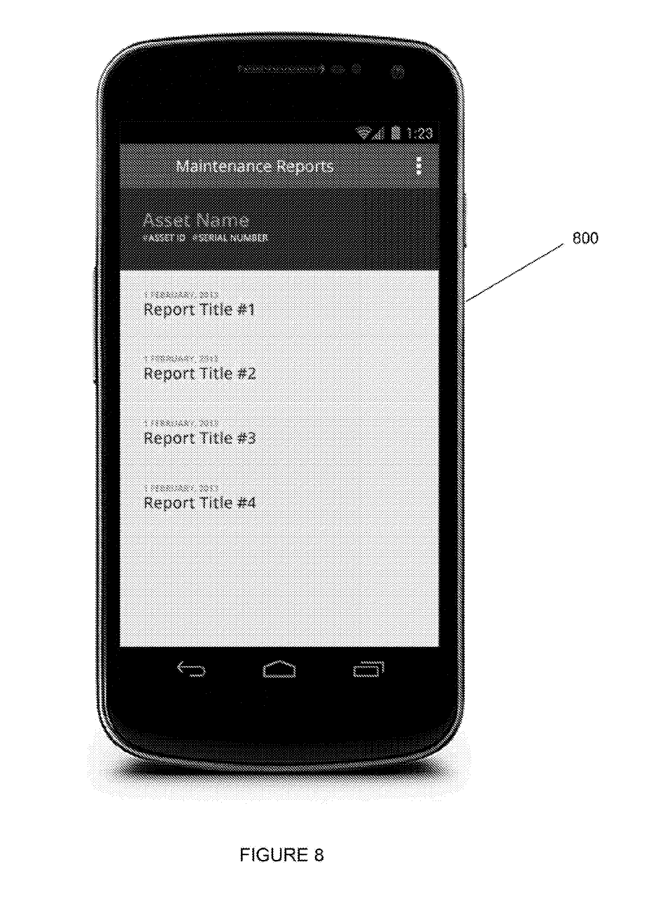

This embodiment of the present invention enables maintenance records to be quickly and easily obtained and recorded in the AtoN database. In particular, though the functionality accessed via the All Reports button 606, which may enable the user to access a list of reports as shown in basic form in FIG. 8. The mobile app in this embodiment also provides the ability for users (in particular, maintenance personnel) to enter data for maintenance activities via the New Report button 604. This data may relate to:
Asset condition—regular/routine checks conducted (and results);
Actions taken—cleaning, parts replacement (with reasons); and
Recommendations—work required (e.g. replacing mooring chain, repainting), actions not taken.

Preferably, these activities are provided as options in a list, such that a user can quickly and easily record which activities were undertaken by selecting from the pre-determined options.

For recommendations, as an example, options are provided to enter details of:
Actions not taken, and reason why (i.e. parts or equipment not available, poor weather/rough seas);
Work required and estimated timeline (i.e. replace mooring chain, within 3-6 months).

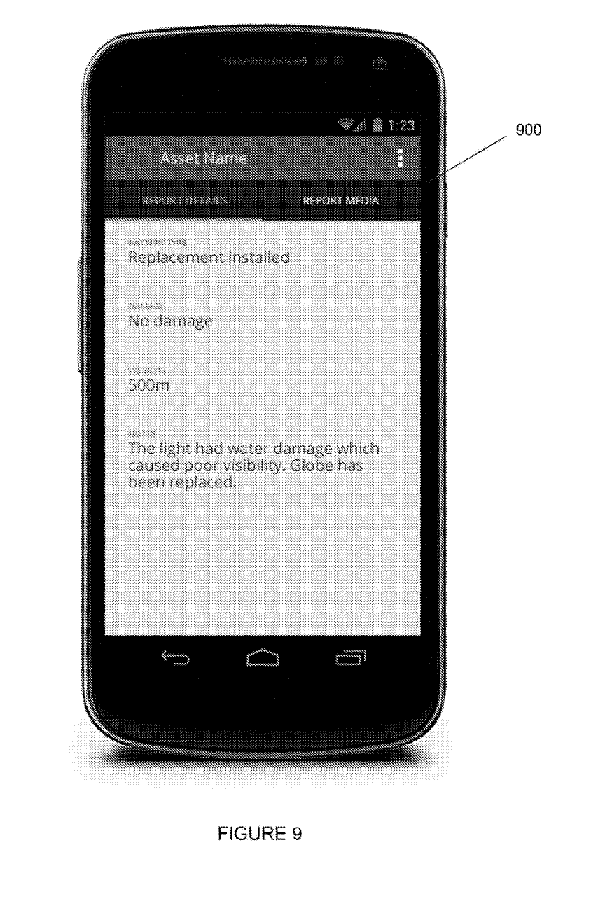

FIG. 9 displays a very basic example of a maintenance report, although clearly further details may also be recorded in a report.

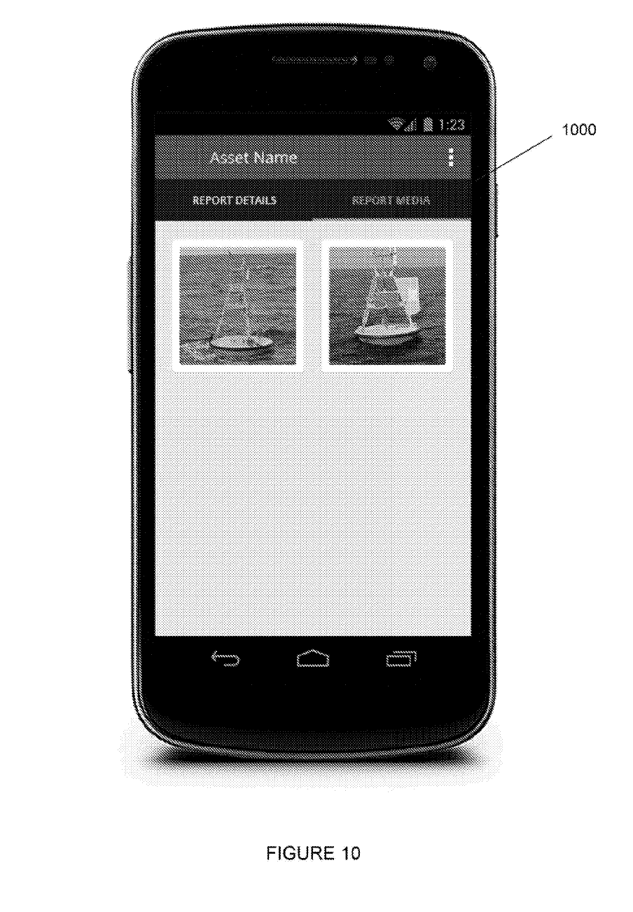

The mobile app also takes advantage of the camera incorporated in many mobile devices. Firstly, for each maintenance activity report, the mobile app also supports the attachment of one or more photographs of the AtoN asset. FIG. 10 shows images that may be taken using the camera and associated with a maintenance report. In this way, the visual characteristics of the asset can be monitored over time.

Secondly, a video camera can be used to assist in conducting system checks. For example, there are over 256 available flashing characters of a marine lantern. Different flash characters indicate different meanings of the navigational mark to the mariner. An important step during maintenance is to verify that the marine lantern is flashing at the correct pre-set character. The mobile application enables the device camera to record the flashing of the marine lantern when the maintenance operator selects the appropriate menu option. The camera captures the flashing pattern over time, and the captured pattern can be compared to the desired pattern, to determine that the marine lantern is flashing to the correct pattern. Accordingly, the present invention provides an important step forward for maintenance personnel.

Similarly, plastic buoys are susceptible to colour fade from sunlight exposure. The mobile computing device's camera can be used to record the surface colour of a buoy and compare this against the IALA recommended colour for the AtoN application. The mobile app may also compare the current recorded colour to the last measured results for a particular AtoN asset, to ascertain the degree and trend of colour fading.

As previously described, the mobile device may have an internal tilt-meter. During maintenance, this can be used to measure and record the orientation of the AtoN asset or a part thereof (e.g. a solar panel). Tracking this information over time may allow a marine authority to understand whether a structure is shifting over time and to what degree, and set parameters as to an acceptable listing angle.

Another feature of the mobile app enables the monitoring of maintenance times through an ‘on location’ timer. Using the mobile device's stop-watch, the timer is started automatically when a navigation aid is selected and the maintenance operator is at its location. This is calculated as the beginning of the maintenance visit. When the operator completes the required data fields and ‘saves’ the asset information the mobile app then automatically ‘stops’ the timer. The period of time lapsed is recorded as the time taken to service the AtoN asset.

Furthermore, as most navigation aids are located outdoors & in demanding environments, it is important to record environmental conditions at the time of maintenance/service. The mobile application may obtain, via a computer network, environmental conditions from published meteorological data and record these against the time and date of servicing. Environmental conditions include tide, wind, temperature, sea conditions. This data can be compared with the length of time spent at each station to predict efficiency measures of future service work.

### Mobile App Functions—Data Synchronisation

In this embodiment, an underlying feature of the mobile app architecture is the (largely) automatic handling of data synchronization with the back-end server. When new data is entered using the mobile app—asset data entry/update, maintenance reports, photos, etc.—the mobile app will check network connectivity and either upload that data immediately, or queue for later submission, as conditions dictate.

### Direct Interface Between AtoN Asset and Server

Some AtoNs may be equipped with their own inbuilt hardware for communications (e.g. GSM/VHF radio etc), as well as self-diagnostics (e.g. for monitoring battery voltage, GPS position, solar panel charging current, flash rate etc). When deployed within an area having communication network coverage, these devices can be configured to communicate directly with the server, so that the information obtained by the AtoN diagnostics can be automatically added to the AtoN database. This would preferably be in addition to any maintenance information obtained through the mobile app.

### Server Reporting/Analytics

As described above, this embodiment of the present invention will enable various reporting/analytic functions to be performed based on the data obtained and entered into the AtoN database. Owners/operators of marine AtoN systems, will have a single source of truth for all AtoN-related asset information and lifecycle data (service histories, parts replacement, lifetime cost, etc.). This will allow detailed information and reporting on key asset metrics; in particular, this will support budgeting and operational forecasts for servicing, maintenance, spare parts and device replacement.

Such information may include average product lifespans and/or failure rates, costs associated with maintenance and spare parts, possible correlations between geographic location (temperature, weather conditions, etc.) and product performance or cost of ownership.

All of these examples are likely to contribute to enhanced decision-making and internal forecasting in areas such as sales and marketing, new product development and inventory management.

The present invention will also enable reports to be generated assisting to schedule further activity for assets already in operation—for example, it will enable the desired service dates for each AtoN asset to be easily calculated and scheduled in advance.

As the present invention may be embodied in several forms without departing from the essential characteristics of the invention, it should be understood that the above described embodiments should not be considered to limit the present invention but rather should be construed broadly. Various modifications, improvements and equivalent arrangements will be readily apparent to those skilled in the art, and are intended to be included within the spirit and scope of the invention.

The word ‘comprising’, and forms of the word ‘comprising’, when used in this specification is taken to specify the presence of stated features, integers, steps or components but does not preclude the presence or addition of one or more other features, integers, steps, components or groups thereof.

In this specification where a document, act or item of knowledge is referred to or discussed, this reference or discussion is not an admission that the document, act or item of knowledge or any combination thereof was at the priority date, publicly available, known to the public, part of the common general knowledge; or known to be relevant to an attempt to solve any problem with which this specification is concerned.

The claims defining the invention are as follows:

1. A computer-implemented method of managing a plurality of aids to navigation, comprising:
(a) maintaining an AtoN database;
(b) recording, in the AtoN database, an identifier for each AtoN asset;
(c) associating, with each identifier, lifecycle information relating to the corresponding AtoN asset.

2. The method of claim 1, wherein the lifecycle information includes one or more of:
(i) a current location of the AtoN asset;
(ii) historical locations of the AtoN asset;
(iii) current deployment details of the AtoN asset;
(iv) historical deployment details of the AtoN asset;
(v) maintenance records of the AtoN asset; or
(vi) operational mode usage data for the AtoN asset.

3. The method of claim 2, wherein at least the current location is recorded for an AtoN asset, and the current location is indicated by a station identifier which may be associated with multiple AtoN assets.

4. The method of claim 3, further comprising:
(a) obtaining, with a mobile computing device, lifecycle information for an AtoN asset; and
(b) updating the AtoN database with the lifecycle information.

5. The method of claim 4, wherein at least the current location is recorded for an AtoN asset, and the current location is obtained at least in part by determining the current location of the mobile computing device.

6. A computer-implemented method of managing a plurality of aids to navigation comprising:
(a) obtaining lifecycle information for an AtoN asset; and
(b) updating an AtoN database with the lifecycle information.

7. The method of claim 6, wherein the lifecycle information includes one or more of:
(i) a current location of the AtoN asset;
(ii) historical locations of the AtoN asset;
(iii) mooring details of the AtoN asset;
(iv) maintenance details of the AtoN asset; or
(v) operational mode usage data for the AtoN asset.

8. The method of claim 7, wherein at least the current location is recorded for an AtoN asset, and further wherein the method is performed by a mobile computing device, the current location being obtained at least in part by determining the current location of the mobile computing device.

9. The method of claim 8, wherein the AtoN asset includes a solar panel, and the method further comprises determining, based on the current location, a desired tilt of the solar panel.

10. The method of claim 9, wherein the mobile computing device includes a tilt-meter, further comprising measuring an angle of at least a part of the AtoN asset using the tilt-meter.

11. The method of claim 10, further comprising:
(a) obtaining a visual and/or audio recording of the AtoN asset;
(b) measuring one or more visual and/or audio characteristics of the AtoN asset, from the recording; and
(c) comparing the one or more measured characteristics to one or more corresponding desired characteristics of the AtoN asset.

12. The method of claim 11, wherein the one or more measured and desired characteristics include a colour of the AtoN device.

13. The method of claim 12, wherein the one or more measured and desired characteristics include a flash rate of a light of the AtoN device.

14. A computer-implemented method of assessing an AtoN asset comprising:
(a) obtaining a visual and/or audio recording of the AtoN asset;
(b) measuring one or more visual and/or audio characteristics of the AtoN asset, from the recording; and
(c) comparing the one or more measured characteristics to one or more corresponding desired characteristics of the AtoN asset.

15. The method of claim 14, wherein the one or more measured and desired characteristics include a colour of the AtoN device.

16. The method of claim 14, wherein the one or more measured and desired characteristics include a flash rate of a light of the AtoN device.

17. A computer-implemented method of deploying an AtoN asset using a mobile computing device having an angle measuring means to measure an angle of tilt of the mobile computing device, the method comprising:
(a) measuring, using the angle measuring means, an angle of the AtoN asset or a part thereof;
(b) comparing the measured angle to a desired angle of the AtoN asset or part thereof; and
(c) adjusting the angle of the AtoN asset or part thereof based on the comparison of the measured angle to the desired angle.

18. A computer-implemented system computer-implemented system for managing a plurality of aids to navigation, comprising:
(a) means for maintaining an AtoN database;
(b) means for recording, in the database, an identifier for each AtoN asset, and
(c) means for associating, with each identifier, lifecycle information relating to the corresponding AtoN asset.

19. A computer-implemented system for managing a plurality of aids to navigation, said system comprising one or more computers including:
(a) at least one processor;
(b) at least one storage medium operatively coupled to said processor, said storage medium containing program instructions for execution by said processor, said program instructions causing said processor to execute the steps of the method of claim 17.

20. A tangible computer-readable medium having computer-executable instructions stored thereon for directing a programmable device to perform the method of claim 17.
